(19) United States
(12) Patent Application Publication
(10) Pub. No.: US 2004/0244818 A1
(43) Pub. Date: Dec. 9, 2004

(54) System and method for cleaning of workpieces using supercritical carbon dioxide

(76) Inventors: Michael A. Fury, San Francisco, CA (US); Robert W. Sherrill, San Rafael, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/846,093

(22) Filed: May 13, 2004

Related U.S. Application Data
(60) Provisional application No. 60/469,826, filed on May 13, 2003.

(51) Int. Cl. B08B 3/00

(52) U.S. Cl. 134/2; 134/10; 134/26; 134/94.1; 134/111; 134/186; 134/902

(57) ABSTRACT

A supercritical CO₂ cleaning system according to the invention can include: a pressure chamber configured to clean a workpiece with supercritical CO₂; an expansion chamber configured to receive an output of the pressure chamber; a CO₂ recycle system configured to receive an expanded CO₂ stream from the expansion chamber, and configured to output a recycled CO₂ stream; a supply of fresh CO₂ configured to output a fresh CO₂ stream; a purification system configured to receive at least one of the fresh CO₂ stream and the recycled CO₂ stream, the purification system configured to output a purified CO₂ stream; and a first co-solvent supply configured to output a first co-solvent stream, where the pressure chamber is configured to receive the purified CO₂ stream and the first co-solvent stream.

### CROSS REFERENCE TO RELATED APPLICATIONS

This application claims priority to U.S. Provisional Application No. 60/469,826, filed May 13, 2003.

### FIELD OF THE INVENTION

The present invention relates to a system and method for precision cleaning of workpieces, such as semiconductor wafers. More particularly, the invention is directed to a system and method in which the amounts of supercritical CO₂ and one or more co-solvents are precisely metered.

### BACKGROUND OF THE INVENTION

Carbon dioxide (CO₂) technology is applied in many industrial processes to significantly reduce or eliminate the use of hazardous chemicals, to conserve natural resources such as water, or to accomplish tasks previously not possible, such as rapid precision cleaning of semiconductor devices.

Manufacture of semiconductor devices typically employs several processing steps that generate chemical residues and particulates on the semiconductor wafer surface. One such processing step is chemical mechanical polishing (CMP), which is used to planarize a wafer surface. The CMP process removes top surface layers from a wafer and leaves a residue of chemicals and particles on the wafer surface that is difficult and problematic to remove using standard post-CMP cleaning methods (e.g., mechanical washing and brushing).

The application of CO₂ cleaning technologies to semiconductor processing provides a fast and effective method to remove chemical residues and particulates. CO₂ can exist as a gas, solid, liquid, or supercritical fluid, depending on the pressure and temperature applied. Typically, in semiconductor applications, CO₂ is used as a supercritical fluid (supercritical CO₂). Supercritical CO₂ retains the properties of a fluid, but has the diffusivity and viscosity of a gas. A high-pressure environment is necessary to maintain CO₂ in a supercritical fluid phase. The solvency of supercritical CO₂ is increased with increasing pressure and is further enhanced by the addition of chemical agents or co-solvents that are reactive towards materials used in semiconductor manufacturing. The supercritical CO₂ (either with a co-solvent or alone) acts as a solvent to remove contaminants from the wafer surface and effectively cleans the surface of the wafer. These properties of supercritical CO₂ make CO₂ a safe, cost-effective, and performance-effective replacement for standard semiconductor cleaning techniques.

U.S. Pat. No. 6,331,487, entitled, “Removal of polishing residue from substrate using supercritical fluid process,” describes a method of cleaning a semiconductor device using supercritical CO₂. In this method, a semiconductor wafer is placed in a pressure chamber and the chamber is sealed and pressurized with the CO₂. As the pressure inside the pressure chamber builds, the CO₂ becomes liquid and then reaches supercritical temperature and pressure. When the desired conditions are reached, a small amount of a chemical agent or co-solvent may be introduced into the supercritical CO₂ stream to facilitate cleaning. CO₂ is then recycled back to a carbon dioxide compressor for reuse. The efficiency of this precision cleaning method is dependent on maintaining an optimal ratio of supercritical CO₂ to co-solvent. For example, an excessive amount of co-solvent can cause corrosion of the wafer surfaces, while insufficient amounts of co-solvent leads to suboptimal cleaning of the wafer surfaces. Unlike the present invention, the '487 patent does not disclose a flexible, responsive system that allows for a readily adaptable system cleaning chemistry.

U.S. Pat. No. 6,099,619, entitled, “Purification of carbon dioxide,” describes an on-site, on-demand method for purifying gaseous CO₂. Typically, CO₂ obtained from commercial suppliers is a gas-saturated liquid that contains various trace contaminants, including oils, water, and particulates and so a method in accordance with the '619 helps reduce the levels of such contaminants. The method comprises passing a stream of CO₂ through a cartridge containing one or more silver-exchanged faujasite beds and a molecular sieve. The '619 patent does not disclose the use of said purification in cleaning systems for semiconductor workpieces. While a preferred application for this purification method in the '619 patent is in the beverage and food industries, the ultra-pure CO₂ is suitable for use in supercritical extraction systems, such as the supercritical CO₂ precision cleaning of semiconductor wafers of the present invention. An on-site, on-demand purification system provides an economical alternative to purchasing expensive ultra-pure CO₂.

U.S. Pat. No. 6,306,564, “Removal of resist or residue from semiconductors using supercritical carbon dioxide,” assigned to Tokyo Electron Limited (Tokyo, JP), describes a commercially available solvent, such as a stripping chemical and/or an organic solvent, that is supported by supercritical CO₂ to remove a resist, its residue, and/or an organic contaminant off the surface of a semiconductor wafer. Supercritical CO₂ has a high solvency that increases with pressure. The supercritical CO₂ permits a reduction in reaction time and amount of chemical utilized for the resist removal process. In a preferred embodiment, the wafer is exposed to the CO₂ and chemical mixture in a process chamber heated to a temperature of 20 to 80° C. at a pressure of 1050 to 6000 psig for a period of 10 seconds to 15 minutes. Unlike the present invention, the '564 patent does not disclose a flexible, responsive system that allows for a readily adaptable system cleaning chemistry.

U.S. Pat. No. 5,944,996, “Cleaning process using carbon dioxide as a solvent and employing molecularly engineered surfactants,” assigned to The University of North Carolina at Chapel Hill (Chapel Hill, N.C.), describes a process for separation of a contaminant from a substrate that carries the contaminant. The process comprises contacting the substrate to a carbon dioxide fluid containing an amphiphilic species so that the contaminant associates with the amphiphilic species and becomes entrained in the carbon dioxide fluid. The substrate is then separated from the carbon dioxide fluid, and then the contaminant is separated from the carbon dioxide fluid. Unlike the present invention, the '996 patent does not disclose a flexible, responsive system that allows for a readily adaptable system cleaning chemistry.

U.S. Pat. No. 5,881,577, “Pressure-swing absorption based cleaning methods and systems,” assigned to Air Liquide America Corporation (Houston, Tex.), describes a cleaning process that includes three main steps: supercritical extraction of soluble contaminants with a solvent composition, subcritical removal of particulate material with agitation, and solvent recovery and recycle. The supercritical extraction of soluble contaminants is performed by pumping a solvent composition into a cleaning vessel containing articles to be cleaned, and pressurizing and heating the fluid in the vessel to a supercritical state. Then the subcritical phase is begun to remove particulate material from the articles by reducing the pressure and temperature of the solvent composition in the cleaning vessel to a subcritical state and reforming the liquid/gas interface. Agitation of the articles in the cleaning vessel is provided by recirculation of the solvent composition or by motion of a mechanical device within the cleaning vessel. Due to a density difference between gas and liquid in the subcritical phase, the degree of agitation and resultant particulate removal is maximized. The solvent composition recovery step preferably includes further depressurization of the fluid to separate and remove soluble and insoluble contaminants from the fluid, allowing this solvent composition to be reused. The system may be operated with any gas with suitable solvent properties such as carbon dioxide, carbon dioxide based mixtures, or other known solvents. Unlike the present invention, the '577 patent does not disclose a flexible, responsive system that allows for a readily adaptable system cleaning chemistry.

U.S. Pat. No. 5,337,446, “Apparatus for applying ultrasonic energy in precision cleaning,” assigned to Autoclave Engineers, Inc. (Erie, Pa.) and Hughes Aircraft Company (Los Angeles, Calif.), describes an apparatus for applying ultrasonic energy in precision cleaning that includes a pressure vessel having a plurality of sonic plates, with or without a rotary device located inside the vessel. The plates may be arranged centrally within the vessel to propagate sonic waves outward, or the plates may be located on an interior wail in the pressure vessel, directed inward. Each plate includes a plurality of sonic transducers, spaced along the longitudinal axis of the pressure vessel. The rotary device may include a plurality of arms carrying removable brush holders or a rotating parts basket. In either case, the device is driven by a motor mounted in a top cover of the pressure vessel. A liquid cleaning fluid, preferably carbon dioxide, is charged in the pressure vessel to submerge the sonic plates and workpieces secured in the pressure vessel. The transducers are then energized and the rotary device engaged to apply both sonic and mechanical agitation to the workpieces for enhanced removal of particulates. The sonic application may be preceded or followed by pressurization of the pressure vessel to above the supercritical pressure of the carbon dioxide for removing dissolvable contaminants from the workpieces. Unlike the present invention, the '446 patent does not disclose a flexible, responsive system that allows for a readily adaptable system cleaning chemistry.

Accordingly, there exists a need for a system that provides for the precision cleaning of workpieces, such as semiconductor wafers, that provides the ability to responsively adjust the cleaning chemistry to optimize the efficiency and effectiveness of the system in relation to the application.

### SUMMARY OF THE INVENTION

One aspect of the present invention relates to a supercritical CO₂ cleaning system that comprises: a pressure chamber configured to clean a workpiece with supercritical CO₂; an expansion chamber configured to receive an output of said pressure chamber; a CO₂ recycle system configured to receive an expanded CO₂ stream from said expansion chamber, and configured to output a recycled CO₂ stream; a supply of fresh CO₂ configured to output a fresh CO₂ stream; a purification system configured to receive at least one of said fresh CO₂ stream and said recycled CO₂ stream, said purification system configured to output a purified CO₂ stream; and a first co-solvent supply configured to output a first co-solvent stream. Advantageously, said pressure chamber can be configured to receive said purified CO₂ stream and said first co-solvent stream.

In one embodiment, the system further contains a controller configured to control a flow rate of at least one of said fresh CO₂ stream, said recycled CO₂ stream, said purified CO₂ stream, and said first co-solvent stream. In the preceding embodiment, there can also be a first device for measuring a flow of said fresh CO₂ supply stream and a second device configured to measure a flow of said recycled CO₂ stream. In the preceding embodiment, there can also be a third device configured to measure a flow of said purified CO₂ stream. In some cases, the third device can be configured to measure a flow of said first co-solvent stream. In any of the preceding embodiments, there can further be a fourth device configured to measure a flow of said purified CO₂ stream.

In another embodiment, the system can contain a co-solvent recycle system configured to receive a used co-solvent stream from said expansion chamber and configured to output a recycled co-solvent stream to said first co-solvent supply. In the preceding embodiment, said co-solvent recycle system can be configured to remove contaminants from said used co-solvent stream. In the preceding embodiment, said co-solvent recycle system can be configured to remove contaminants from said used co-solvent stream by distilling or filtering said used co-solvent stream.

In another embodiment, said purification system is configured to receive said fresh CO₂ stream and said recycled CO₂ stream.

In yet another embodiment, said purification system is configured to receive said fresh CO₂ stream, and said pressure chamber is configured to receive said recycled CO₂ stream. In the preceding embodiment, there can be a controller configured to control a flow rate of said first co-solvent stream based at least in part on a first co-solvent content of said recycled CO₂ stream. In the preceding embodiment, there can also be a second co-solvent supply configured to output a second co-solvent stream to said pressure chamber while said first co-solvent stream is output to said pressure chamber. In the preceding embodiment, there can further be a controller (the controller may be the same as the controller for the first co-solvent stream, or it may be different) configured to control a flow rate of said second co-solvent stream based at least in part on a second co-solvent content of said recycled CO₂ stream.

In another embodiment, the pressure chamber is configured to clean said workpiece with ultrasonic energy in conjunction with said supercritical CO₂.

In still another embodiment, said CO₂ recycle system can be configured either to condense or alternately to expand said expanded CO₂ stream.

In yet another embodiment, said expansion chamber is configured to expand said output of said pressure chamber and to separate said expanded output into a used co-solvent stream and an expanded CO₂ stream. In the preceding embodiment, said expansion chamber can be configured to expand said output of said pressure chamber so that said expanded CO₂ stream can advantageously be in the form of a fog or mist, or alternately to expand and heat to form a gas.

In one embodiment, the purification system is configured so that said purified CO₂ stream is at least 99.9999% pure.

In another embodiment, said first co-solvent supply is configured to approximately saturate said first co-solvent stream with CO₂. In yet another embodiment, said first co-solvent supply is configured to output said first co-solvent stream via a port, and said first co-solvent supply includes a purger configured to purge, using a measured quantity of CO₂, said port of said first co-solvent.

In another embodiment, there can be a second co-solvent supply configured to output a second co-solvent stream to said pressure chamber. In the preceding embodiment, said second co-solvent supply can be configured to output said second co-solvent stream to said pressure chamber after said first co-solvent stream is output to said pressure chamber, and/or said second co-solvent stream can have a volatility substantially greater than said first co-solvent stream. In the preceding embodiment, said second co-solvent supply can be configured to output said second co-solvent stream to said pressure chamber during a final wash of said workpiece. In any of the preceding embodiments, there can also be a third co-solvent supply configured to output a third co-solvent stream to said pressure chamber.

Another aspect of the present invention relates to a method for cleaning a workpiece using the supercritical CO₂ system according to the invention.

In one embodiment, the method can advantageously include: a) providing a pressure chamber configured to clean said workpiece with said supercritical CO₂; b) introducing said workpiece into said pressure chamber; c) introducing a purified CO₂ stream from a purifier into said pressure chamber at least until said purified CO₂ stream is supercritical; d) introducing a first co-solvent stream into said pressure chamber; e) removing a mixture of a used CO₂ stream and a first used co-solvent stream from said pressure chamber; f) expanding said mixture; g) separating said expanded mixture into said used CO₂ stream and said first used co-solvent stream; h) condensing and/or compressing said used CO₂ stream; and i) either purifying said used CO₂ stream with said purifier or introducing said used CO₂ stream into said pressure chamber.

In another embodiment, the method can include the following steps, preferably performed after steps a)-e): j) introducing a final wash into said pressure chamber; k) removing said final wash from said pressure chamber; and l) removing said workpiece from said pressure chamber.

In another embodiment, said final wash includes said purified CO₂ stream. In this embodiment, said final wash can include a second co-solvent stream preferably having a volatility substantially greater than that of said first co-solvent stream.

In another embodiment, said final wash includes a liquid purified CO₂ stream. In this embodiment, the method can further include applying ultrasonic energy to said workpiece preferably after step j) and also preferably before step k).

In another embodiment, the method can further include: m) introducing a second co-solvent into said pressure chamber, preferably such that said second co-solvent stream having a volatility substantially greater than said first co-solvent stream; and n) removing a mixture of said used CO₂ stream and a second used co-solvent stream from said pressure chamber. In this embodiment, the steps m) and n) can be performed preferably after steps a)-e) and also preferably before steps j)-l).

In one embodiment, said purifier is configured to purify a fresh CO₂ stream. In this embodiment, the flow of said fresh CO₂ stream can advantageously be measured. Alternately or additionally, a flow of said first co-solvent stream can also be measured.

In another embodiment, contaminants can be from said first used co-solvent stream, preferably by distillation and/or filtering.

In one embodiment, step i) includes purifying said used CO₂ stream with said purifier, preferably such that said purifier is configured to purify a fresh CO₂ stream and said used CO₂ stream.

In another embodiment, step i) includes introducing said used CO₂ stream into said pressure chamber. In this embodiment, a flow rate of said first co-solvent stream can be controlled based at least in part on a first co-solvent content of said used CO₂ stream.

In yet another embodiment, step i) can include introducing said used CO₂ stream into said pressure chamber. Preferably also in this embodiment, a flow rate of said first co-solvent stream can be controlled based at least in part on a first co-solvent content of said used CO₂ stream. Preferably also in this embodiment, a flow rate of said second co-solvent stream can be controlled based at least in part on a second co-solvent content of said used CO₂ stream.

In another embodiment, ultrasonic energy can be applied to said workpiece.

In another embodiment, step f) includes expanding said mixture so that said used CO₂ stream is in the form of a fog or mist, or alternately in the form of a gas.

In one embodiment, said purified CO₂ stream is at least 99.9999% pure.

In another embodiment, said first co-solvent stream can be approximately saturated with CO₂, preferably before step d).

In yet another embodiment, step d) includes introducing said first co-solvent stream into said pressure chamber via a port. Preferably also in this embodiment, more preferably after step d), said port can be purged of said first co-solvent stream using a measured quantity of CO₂.

Another aspect of the invention relates to a method for calculating a cost to a customer for supercritical carbon dioxide cleaning of a workpiece according to the invention. Advantageously, this method can include: determining a quantity of fresh CO₂ that is input into a purifier; determining a total quantity of CO₂ that is input into a pressure chamber; determining a desired first co-solvent concentration in said pressure chamber based at least in part on said total quantity of CO₂; maintaining said desired first co-solvent concentration in said pressure chamber; determining a quantity of first co-solvent that is input into said pressure chamber during said maintaining; and calculating said cost to said customer based at least in part on said quantity of fresh CO₂ and said quantity of said first co-solvent. In one embodiment, said total quantity of CO₂ that is input into said pressure chamber can be purified CO₂.

In another embodiment, the method can also include: determining a desired second co-solvent concentration in said pressure chamber based at least in part on said total quantity of CO₂; maintaining said desired second co-solvent concentration in said pressure chamber; determining a quantity of second co-solvent that is input into said pressure chamber during said maintaining; and calculating said cost to said customer based at least in part on said quantity of fresh CO₂ and said quantity of said second co-solvent.

### BRIEF DESCRIPTION OF THE DRAWINGS

The present invention can be described with reference to the attached drawings, in which:

FIG. 1 shows a block diagram of one embodiment of the present invention; and

FIG. 2 shows a block diagram of another embodiment of the present invention.

### DETAILED DESCRIPTION OF THE PREFERRED EMBODIMENTS

With the cleaning of semiconductor workpieces, for example, the particular process will result in certain residues that are particular to that process, including the composition of the workpiece layers, the process additives, process steps and process conditions. In particular, certain co-solvent chemistries will be preferred to remove the etching residues generated in particular processes. The preferred co-solvent chemistries will effectively and efficiently remove the particular etching residues without damaging the workpiece. The compositions of the etching residues generated will vary due to both the process and the conditions of the particular process, thereby requiring the ability to responsively control the co-solvent chemistries and the ratio of the co-solvent to the CO₂. This is achieved in the present invention with a plurality of mass flow controllers or meters to provide accurate delivery and recording of precise amounts of fresh CO₂, recycled CO₂, purified CO₂ stream, co-solvents, and recycled co-solvents. Further, depending on the steps of the process (e.g., wet etching, dry etching, ashing, ion implantation, CMP), the composition of the workpiece layers (e.g., metallurgies, dielectric layers, doping), the process additives (e.g., photoresist, etchant, developer), and process conditions (e.g., temperature), different amount of fresh CO₂, recycled CO₂, purified CO₂ stream, co-solvents, and recycled co-solvents will be preferred to optimize the efficiency and effectiveness of the cleaning process, including cost effectiveness. If provided with a responsive, flexible CO₂ and co-solvent cleaning system, the process engineer will be able to respond to design and adapt the cleaning system to achieve the desired outcome.

The aforementioned U.S. Pat. Nos. 6,331,487 and 6,099,619 are incorporated by reference to the extent necessary to understand the present invention.

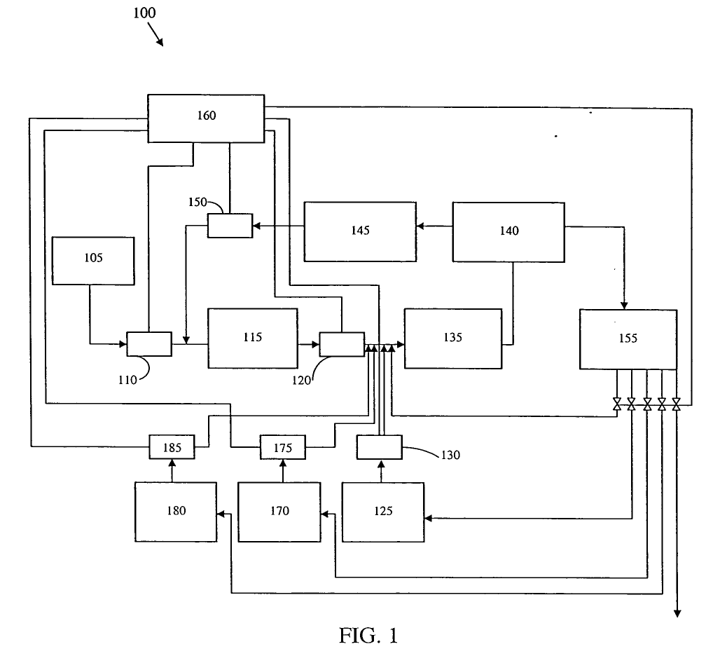

FIG. 1 is a schematic representation of a system 100 for processing a workpiece such as a semiconductor wafer. The system 100 may include a fresh CO₂ supply 105, a fresh CO₂ meter 110, a purification system 115, a CO₂ meter 120, a first co-solvent supply 125, a first co-solvent meter 130, a pressure chamber 135, an expansion chamber 140, a CO₂ recycle system 145, a recycled CO₂ meter 150, a co-solvent recycle system 155, and a control means 160. The system 100 may also include a second co-solvent supply 170 with a corresponding second co-solvent meter 175, and a third co-solvent supply 180 with a corresponding third co-solvent meter 185. Depending on the co-solvent system used, the co-solvent recycle system can be controlled to recycle an amount of the co-solvent to several delivery points, to be determined by one of skill in the art to suit the system design. The system 100 may include more co-solvent supplies, as would be known to one skilled in the art.

Fresh CO₂ supply 105 may be any commercially available, industrial grade liquid CO₂.

Fresh CO₂ meter 110, CO₂ meter 120, first co-solvent meter 130, recycled CO₂ meter 150, second co-solvent meter 175, and third co-solvent meter 185 may each be a conventional mass flow controller or meter suitable for controlling and/or metering the volume of fresh CO₂, total CO₂, first co-solvent, recycled CO₂, second co-solvent, and third so-solvent, respectively. Preferably, such a device includes a check valve to prevent back-flow.

Fresh CO₂ meter 110, CO₂ meter 120, first co-solvent meter 130, recycled CO₂ meter 150, second co-solvent meter 175, and third co-solvent meter 185 may be interfaced with control means 160, such as a conventional computer that includes analog/digital hardware and software that specifies algorithms to (1) provide the correct amount of fresh CO₂ to system 100, (2) provide the correct amount of first co-solvent (and/or second co-solvent, and/or third co-solvent, as the case may be) to system 100, and (3) record the flow of each for charging the customer the correct amount for the chemistry used in system 100.

Purification system 115 may be any combination of conventional distillation devices, chemistries, and/or molecular sieves that effectively removes impurities such as oil, water, sulfur, and particulates from commercially available liquid CO₂ and recycled CO₂. Such purification means are well known to one skilled in the art. For the purposes of the present invention, purification system 115 should achieve stringent standards of purity, such that the resulting CO₂ is very pure, such as 99.9999% pure. An example of a suitable purification means is disclosed in U.S. Pat. No. 6,099,619, entitled, “Purification of carbon dioxide,” which describes an on-site, on-demand method for purifying gaseous CO₂. Such a purification method reduces the contaminants typically found in CO₂ obtained from commercial suppliers, such as oils, water, and particulates. The method comprises passing a stream of CO₂ through a cartridge containing one or more silver-exchanged faujasite beds and a molecular sieve. A method applicable in the present invention is to passing the stream of carbon dioxide through a silver-exchanged faujasite and a molecular sieve selected from the group consisting of an MH-type molecular sieve with a suitable Si:Al ratio and using a suitable proportion of faujasite and sieve.

First co-solvent supply 125, second co-solvent supply 170, and third co-solvent supply 180 may be any conventional chemical additive or co-solvent, such as N-Methyl-2-pyrolidone (NMP) or N,N-Dimethyl acetamide (DMAC), that is typically used to strip photoresist. Where a second co-solvent supply 170 and/or third co-solvent supply 180 is present, the system 100 may be configured to deliver all of the co-solvents to the pressure chamber 135 approximately simultaneously with the CO₂. Alternatively, the system 100 may be configured to first clean the workpiece with a mixture of the first co-solvent and CO₂, and subsequently clean the workpiece with a mixture of the second co-solvent and CO₂, and so forth. In a preferred embodiment, where a second co-solvent supply 170 and/or third co-solvent supply 180 are present, they may have a volatility or boiling point different from the first co-solvent. For example, where the system 100 has a first co-solvent supply 125 and a second co-solvent supply 170, and where the system 100 is configured to wash the workpiece with the second co-solvent after washing it with the first co-solvent, the second co-solvent may have a volatility higher than the first co-solvent. Because the later wash is more volatile than the prior wash, there is less risk that a co-solvent residue will remain on the workpiece. Further, while a final rinse of a workpiece usually includes only CO₂, the final rinse may also include a second co-solvent and/or third co-solvent having a volatility higher than the first co-solvent.

As is known to those skilled in the art, a co-solvent enhances the solvency of the CO₂ and is typically added in small quantities relative to the quantity of the CO₂. The controller 160 and first co-solvent meter 130 may be used, in conjunction with fresh CO₂ meter 110, recycled CO₂ meter 150 and, when present, CO₂ meter 120, to help ensure an appropriate ratio (or concentration) of first co-solvent in the CO₂. Where a second co-solvent supply 170 and/or a third co-solvent supply 180 are present, a corresponding second co-solvent meter 175 and/or third co-solvent meter 185 may be used in conjunction with the controller 160 and other meters to ensure an appropriate ratio (or concentration) of the corresponding second and/or third co-solvent in the CO₂. Further, a mixture of co-solvents may be provided by first co-solvent supply 125, and the overall ratio of these co-solvents to CO₂ would then be controlled.

In a preferred embodiment, a co-solvent is approximately saturated with CO₂ (e.g., at the pressure of the supercritical CO₂) before being added to the pressure chamber 135. This will prevent or assuage a dissolving reaction between the co-solvent and CO₂ in the pressure chamber 135. In another preferred embodiment, each co-solvent supply 125, 170, 180 is configured to output the corresponding co-solvent via a port, and has a purger configured to purge the port of the corresponding co-solvent using a measured quantity of CO₂. If the port is not purged of the corresponding co-solvent, then, even when the flow of the corresponding co-solvent is stopped via the corresponding meter 130, 175, 185, a small quantity of co-solvent will remain in the corresponding line connecting the corresponding co-solvent supply 125, 170, 180 to the pressure chamber 135, resulting in an imprecise or uncontrolled delivery of the corresponding co-solvent.

Pressure chamber 135 is any conventional high-pressure processing chamber, such as the chamber described in U.S. Pat. No. 5,337,446, entitled, “Apparatus for applying ultrasonic energy in precision cleaning,” that permits the use of supercritical CO₂ and co-solvents as cleaning agents. The pressure chamber 135 may be configured to clean a workpiece with ultrasonic energy in conjunction with supercritical CO₂.

Expansion chamber 140 is a separator in which the supercritical fluid is first made non-supercritical and then the resulting gas (corresponding to the CO₂) and liquid (corresponding to the co-solvent) are separated. In other words, during the expansion of the supercritical fluid, the expansion chamber 140 is configured to recover the liquid (corresponding to the co-solvent) that drops out of the previously supercritical fluid. In expansion chamber 140, CO₂ is converted to a gas, while the co-solvent becomes and/or remains a liquid. Once the gaseous CO₂ is condensed in CO₂ recycle system 145, the CO₂ is available for purification and reutilization. CO₂ recycle system 145 is any conventional condensing system, such as a heat exchanger and compressor. For example, CO₂ recycle system 145 may be configured to compress the expanded CO₂ (coming from the expansion chamber 140) to supercriticality.

Co-solvent recycle system 155 may be any combination of conventional distillation devices, chemistries, and/or molecular sieves that effectively removes contaminants and particles (residues) from the co-solvent. Since some co-solvents cannot efficiently be recycled, it is understood that co-solvent recycle system 155 is optional, and that the present invention encompasses embodiments in which no such co-solvent recycle system 155 is present. In such case, the corresponding stream from expansion chamber 140 is considered waste. Where a second co-solvent supply 170 and/or third co-solvent supply 180 are present, the co-solvent recycle system 155 may include means for separating the first co-solvent from the second co-solvent from the third co-solvent. For example, where the three kinds of co-solvents have different volatilities, they may be separated by, e.g., distillation, as is known to one skilled in the art.

In operation, fresh CO₂ from fresh CO₂ supply 105 is fed to pressure chamber 135 through fresh CO₂ meter 110 and purification system 115. Fresh CO₂ meter 110 provides accurate delivery and recording of the precise amount of fresh CO₂ that is fed to pressure chamber 135. The CO₂ provided by fresh CO₂ supply 105 is industrial grade and contains impurities that are removed by purification system 115.

The metered amount of fresh, purified CO₂ is combined with a metered amount of first co-solvent supplied by first co-solvent supply 125 via first co-solvent meter 130 and fed into pressure chamber 135 for precision cleaning of a device such as a semiconductor wafer. Where present, a metered amount of second co-solvent and/or third co-solvent may either be combined with the mixture of purified CO₂ and first co-solvent (in the embodiment where the workpiece is washed with all co-solvents simultaneously), or else be combined with only the purified CO₂ (in the embodiment where the workpiece is washed with the second and/or third co-solvent after being washed with the first co-solvent). Following removal of chemical residues and particulates from the wafer/workpiece surface, pressure chamber 135 is flushed and vented. The CO₂/co-solvent mixture (which may contain more than one kind of co-solvent) is collected in expansion chamber 140, where the CO₂ is vaporized into either a gas or a fog and is subsequently condensed in CO₂ recycle system 145. The recycled CO₂ is then available for reuse and is fed back into purification system 115 via recycled CO₂ meter 150.

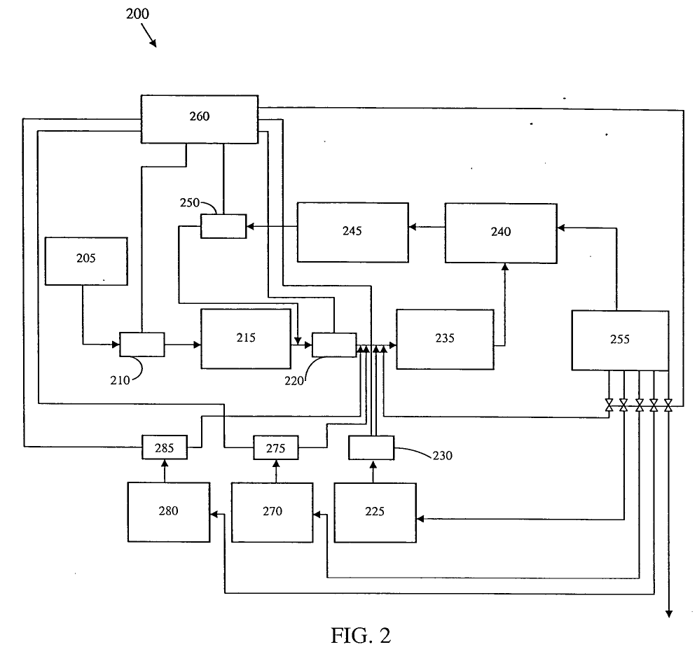

Alternatively, as shown in FIG. 2, the recycled CO₂ need not be purified by the purification system 215 at all, or at least need not be purified during every cycle, before being fed into the pressure chamber 235. The recycled CO₂ may contain small quantities of the first co-solvent. In this embodiment, the control means 260 may be configured to measure a content of the first co-solvent in the recycled CO₂ and, based in part on a desired first co-solvent ratio/concentration in the CO₂, adjust a quantity of additional first co-solvent added to the CO₂ via first co-solvent meter 230. Where a second 270 and/or third 280 co-solvent supply is present, the control means 260 may be configured to measure a content of the second and/or third co-solvent in the recycled CO₂ and adjust a quantity of additional second and/or third co-solvent added to the CO₂ via the second 275 and/or third 285 co-solvent meter.

Fresh CO₂ meter 110 and recycled CO₂ meter 150 provide information on the amount of CO₂ entering purification system 115 and the amount of CO₂ used in the operation of system 100. Control means 160 collects information tracked by fresh CO₂ meter 110 and recycled CO₂ meter 150, thereby providing both a way to monitor the ratio of fresh CO₂ to recycled CO₂ and a record of the amount of fresh CO₂ used in the operation of system 100.

Co-solvent meters 130, 175, 185 provide information on the amount of first, second, and third co-solvents, respectively, used in the operation of system 100. Control means 160 also provides a way to calculate (1) the amount of fresh CO₂ needed to replenish the stream and (2) the amount of co-solvent(s) required in system 100.

Accurate monitoring and recording of the amount of CO₂ used in system 100, the amount of co-solvent(s) used in system 100, and the total amount of CO₂ purified in purification system 115 provides the information required to determine the cost to a customer of operating system 100. For example, the price to the customer could be calculated by determining a quantity of fresh CO₂ that is input into the purification system 115 via the fresh CO₂ meter 110; determining a total quantity of CO₂ that is input into the pressure chamber 135 via the CO₂ meter 120; determining a desired first co-solvent concentration in the pressure chamber 135 based at least in part on the total quantity of CO₂ as measured by the CO₂ meter 120; maintaining this desired first co-solvent concentration in the pressure chamber 135 by adjusting the flow of the first co-solvent from the first co-solvent supply 125 via the control means 160 and the first co-solvent meter 130; determining a quantity of first co-solvent that is input into the pressure chamber 135 during this maintaining; and calculating the cost to the customer based at least in part on the quantity of fresh CO₂ and the quantity of the first co-solvent. A similar method could be used where second and/or third co-solvents are present. This method can be applied equally to system 200.

In an alternative embodiment of the present invention, CO₂ meter 120 may be used to monitor the amount of total CO₂ fed into system 100 following purification of the fresh CO₂/recycled CO₂ mixture. CO₂ meter 120 provides additional information to accurately determine the ratio of CO₂ to co-solvent(s) used in the operation of system 100. This alternative embodiment can also be applied to system 200.

In another alternative embodiment of the present invention, the liquid co-solvent(s) recovered from expansion chamber 140 can be recycled in co-solvent recycle system 155 using conventional chemistries and techniques. For example, the photoresist-stripping chemical NMP is recyclable by distillation. This alternative embodiment can also be applied to system 200.

While the above invention has been described with reference to certain preferred embodiments and demonstrated with respect to particular experiments, it should be kept in mind that the scope of the present invention is not limited to these. Thus, one skilled in the art may find variations of these preferred embodiments which, nevertheless, fall within the spirit of the present invention, whose scope is defined by the claims set forth below.

What is claimed is:

1. A supercritical CO₂ cleaning system, comprising:
a pressure chamber configured to clean a workpiece with supercritical CO₂;
an expansion chamber configured to receive an output of said pressure chamber;
a CO₂ recycle system configured to receive an expanded CO₂ stream from said expansion chamber, and configured to output a recycled CO₂ stream;
a supply of fresh CO₂ configured to output a fresh CO₂ stream;
a purification system configured to receive at least one of said fresh CO₂ stream and said recycled CO₂ stream, said purification system configured to output a purified CO₂ stream; and
a first co-solvent supply configured to output a first co-solvent stream,
wherein said pressure chamber is configured to receive said purified CO₂ stream and said first co-solvent stream.

2. The system according to claim 1, further comprising a controller configured to control a flow rate of at least one of said fresh CO₂ stream, said recycled CO₂ stream, said purified CO₂ stream, and said first co-solvent stream.

3. The system according to claim 2, comprising a first device for measuring a flow of said fresh CO₂ supply stream; and a second device configured to measure a flow of said recycled CO₂ stream.

4. The system according to claim 3, further comprising a third device configured to measure a flow of said purified CO₂ stream.

5. The system according to claim 3, further comprising a third device configured to measure a flow of said first co-solvent stream.

6. The system according to claim 4, further comprising a fourth device configured to measure a flow of said purified CO₂ stream.

7. The system according to claim 1, further comprising a co-solvent recycle system configured to receive a used co-solvent stream from said expansion chamber and configured to output a recycled co-solvent stream to said first co-solvent supply.

8. The system according to claim 7, wherein said co-solvent recycle system is configured to remove contaminants from said used co-solvent stream.

9. The system according to claim 8, wherein said co-solvent recycle system is configured to remove contaminants from said used co-solvent stream by distilling said used co-solvent stream.

10. The system according to claim 8, wherein said co-solvent recycle system is configured to remove contaminants from said used co-solvent stream by filtering said used co-solvent stream.

11. The system according to claim 1, wherein said purification system is configured to receive said fresh CO₂ stream and said recycled CO₂ stream.

12. The system according to claim 1, wherein said purification system is configured to receive said fresh CO₂ stream, and wherein said pressure chamber is configured to receive said recycled CO₂ stream.

13. The system according to claim 12, further comprising a controller configured to control a flow rate of said first co-solvent stream based at least in part on a first co-solvent content of said recycled CO₂ stream.

14. The system according to claim 13, further comprising a second co-solvent supply configured to output a second co-solvent stream to said pressure chamber while said first co-solvent stream is output to said pressure chamber.

15. The system according to claim 14, further comprising a controller configured to control a flow rate of said second co-solvent stream based at least in part on a second co-solvent content of said recycled CO₂ stream.

16. The system according to claim 1, wherein the pressure chamber is configured to clean said workpiece with ultrasonic energy in conjunction with said supercritical CO₂.

17. The system according to claim 1, wherein said CO₂ recycle system is configured to condense said expanded CO₂ stream.

18. The system according to claim 1, wherein said CO₂ recycle system is configured to compress said expanded CO₂ stream.

19. The system according to claim 1, wherein said expansion chamber is configured to expand said output of said pressure chamber and to separate said expanded output into a used co-solvent stream and an expanded CO₂ stream.

20. The system according to claim 19, wherein said expansion chamber is configured to expand said output of said pressure chamber so that said expanded CO₂ stream is in the form of a fog or mist.

21. The system according to claim 19, wherein said expansion chamber is configured to expand and heat said output of said pressure chamber so that said expanded CO₂ stream is in the form of a gas.

22. The system according to claim 1, wherein the purification system is configured so that said purified CO₂ stream is at least 99.9999% pure.

23. The system according to claim 1, wherein said first co-solvent supply is configured to approximately saturate said first co-solvent stream with CO₂.

24. The system according to claim 1, wherein said first co-solvent supply is configured to output said first co-solvent stream via a port, and wherein said first co-solvent supply includes a purger configured to purge, using a measured quantity of CO₂, said port of said first co-solvent.

25. The system according to claim 1, further comprising a second co-solvent supply configured to output a second co-solvent stream to said pressure chamber.

26. The system according to claim 25, wherein said second co-solvent supply is configured to output said second co-solvent stream to said pressure chamber after said first co-solvent stream is output to said pressure chamber, and wherein said second co-solvent stream has a volatility substantially greater than said first co-solvent stream.

27. The system according to claim 26, wherein said second co-solvent supply is configured to output said second co-solvent stream to said pressure chamber during a final wash of said workpiece.

28. The system according to claim 25, further comprising a third co-solvent supply configured to output a third co-solvent stream to said pressure chamber.

29. A method for cleaning a workpiece with supercritical CO₂, comprising:
a) providing a pressure chamber configured to clean said workpiece with said supercritical CO₂;
b) introducing said workpiece into said pressure chamber;
c) introducing a purified CO₂ stream from a purifier into said pressure chamber at least until said purified CO₂ stream is supercritical;
d) introducing a first co-solvent stream into said pressure chamber;
e) removing a mixture of a used CO₂ stream and a first used co-solvent stream from said pressure chamber;
f) expanding said mixture;
g) separating said expanded mixture into said used CO₂ stream and said first used co-solvent stream;
h) at least one of:
condensing said used CO₂ stream; and
compressing said used CO₂ stream; and
i) exactly one of:
purifying said used CO₂ stream with said purifier; and
introducing said used CO₂ stream into said pressure chamber.

30. The method according to claim 29, further comprising the following steps performed after steps a)-e):
j) introducing a final wash into said pressure chamber;
k) removing said final wash from said pressure chamber; and
l) removing said workpiece from said pressure chamber.

31. The method according to claim 30, wherein said final wash includes said purified CO₂ stream.

32. The method according to claim 31, wherein said final wash includes a second co-solvent stream having a volatility substantially greater than that of said first co-solvent stream.

33. The method according to claim 30, wherein said final wash includes a liquid purified CO₂ stream, and wherein the method further comprises applying ultrasonic energy to said workpiece after step j) and before step k).

34. The method according to claim 30, further comprising:
m) introducing a second co-solvent into said pressure chamber, said second co-solvent stream having a volatility substantially greater than said first co-solvent stream; and
n) removing a mixture of said used CO₂ stream and a second used co-solvent stream from said pressure chamber.

35. The method according to claim 34, wherein steps m) and n) are performed after steps a)-e) and before steps j)-l).

36. The method according to claim 29, wherein said purifier is configured to purify a fresh CO₂ stream.

37. The method according to claim 36, further comprising measuring a flow of said fresh CO₂ stream.

38. The method according to claim 29, further comprising measuring a flow of said first co-solvent stream.

39. The method according to claim 38, further comprising measuring a flow of said purified CO₂ stream and said used CO₂ stream.

40. The method according to claim 29, further comprising removing contaminants from said first used co-solvent stream.

41. The method according to claim 40, wherein said removing comprises distilling said first used co-solvent stream.

42. The method according to claim 40, wherein said removing comprises filtering said first used co-solvent stream.

43. The method according to claim 29, wherein step i) comprises purifying said used CO₂ stream with said purifier, and wherein said purifier is configured to purify a fresh CO₂ stream and said used CO₂ stream.

44. The method according to claim 29, wherein step i) comprises introducing said used CO₂ stream into said pressure chamber.

45. The method according to claim 44, further comprising controlling a flow rate of said first co-solvent stream based at least in part on a first co-solvent content of said used CO₂ stream.

46. The method according to claim 34, wherein step i) comprises introducing said used CO₂ stream into said pressure chamber; wherein the method further comprises controlling a flow rate of said first co-solvent stream based at least in part on a first co-solvent content of said used CO₂ stream, and wherein the method further comprises controlling a flow rate of said second co-solvent stream based at least in part on a second co-solvent content of said used CO₂ stream.

47. The method according to claim 29, further comprising applying ultrasonic energy to said workpiece.

48. The method according to claim 29, wherein step f) comprises expanding said mixture so that said used CO₂ stream is in the form of a fog or mist.

49. The method according to claim 29, wherein step f) comprises expanding said mixture so that said used CO₂ stream is in the form of a gas.

50. The method according to claim 29, wherein said purified CO₂ stream is at least 99.9999% pure.

51. The method according to claim 29, further comprising approximately saturating said first co-solvent stream with CO₂ before step d).

52. The method according to claim 29, wherein step d) comprises introducing said first co-solvent stream into said pressure chamber via a port; and wherein the method further comprises, after step d), purging said port of said first co-solvent stream using a measured quantity of CO₂.

53. A method for calculating a cost to a customer for supercritical carbon dioxide cleaning of a workpiece, the method comprising:
determining a quantity of fresh CO₂ that is input into a purifier;
determining a total quantity of CO₂ that is input into a pressure chamber;
determining a desired first co-solvent concentration in said pressure chamber based at least in part on said total quantity of CO₂;
maintaining said desired first co-solvent concentration in said pressure chamber;
determining a quantity of first co-solvent that is input into said pressure chamber during said maintaining; and
calculating said cost to said customer based at least in part on said quantity of fresh CO₂ and said quantity of said first co-solvent.

54. The method according to claim 53, wherein said total quantity of CO₂ that is input into said pressure chamber is purified CO₂.

55. The method according to claim 53, further comprising:
determining a desired second co-solvent concentration in said pressure chamber based at least in part on said total quantity of CO₂;
maintaining said desired second co-solvent concentration in said pressure chamber;
determining a quantity of second co-solvent that is input into said pressure chamber during said maintaining; and
calculating said cost to said customer based at least in part on said quantity of fresh CO₂ and said quantity of said second co-solvent.
